(19) United States
(12) Patent Application Publication
(10) Pub. No.: US 2020/0306950 A1
(43) Pub. Date: Oct. 1, 2020

(54) Magnetic Tool Rack

(71) Applicant: Maan-Jyi Chang, Taichung City (TW)

(72) Inventor: Maan-Jyi Chang, Taichung City (TW)

(21) Appl. No.: 16/362,813

(22) Filed: Mar. 25, 2019

(51) Int. Cl. B25H 3/04

(52) U.S. Cl. CPC B25H 3/04; F16B 2001/0035; A45F 2200/0575

(57) ABSTRACT

A magnetic tool rack includes a magnetic layer, an upper surface layer mounted on the magnetic layer, and a lower surface layer mounted on the magnetic layer. The magnetic layer includes a plank provided with a plurality of mounting grooves, and a plurality of magnetic members mounted in the mounting grooves of the plank. The plank of the magnetic layer is made of flexible material. The magnetic members have magnetic poles that are directed at the same direction in the mounting grooves. The upper surface layer is a thin layer made of flexible material and is stuck to a first face of the magnetic layer. The lower surface layer is a thin layer made of flexible material and is stuck to a second face of the magnetic layer.

### BACKGROUND OF THE INVENTION

### 1. Field of the Invention

The present invention relates to a tool rack and, more particularly, to a magnetic tool rack for attracting hand tools magnetically.

### 2. Description of the Related Art

A conventional magnetic tool rack comprises a magnetic board for hold metal hand tools by a magnetically attracting force. However, the magnetic board is solid and is not flexed, such that the magnetic board is only attached to a plane surface, and is not available for a non-plane surface. In addition, the magnetic board is made of magnetic material with a large area, thereby increasing the cost of production. Further, the magnetic board is a single board whose magnetic lines of force between the south pole and the north pole are too weak, such that the magnetically attractive force and the positioning strength of the magnetic board are insufficient.

### BRIEF SUMMARY OF THE INVENTION

The primary objective of the present invention is to provide a magnetic tool rack that attaches metal hand tools to a metal surface of an object.

In accordance with the present invention, there is provided a magnetic tool rack comprising a magnetic layer, an upper surface layer mounted on the magnetic layer, and a lower surface layer mounted on the magnetic layer. The magnetic layer includes a plank provided with a plurality of mounting grooves, and a plurality of magnetic members mounted in the mounting grooves of the plank. The plank of the magnetic layer is made of flexible material. The magnetic members have magnetic poles that are directed at the same direction in the mounting grooves. The upper surface layer is a thin layer made of flexible material. The upper surface layer is stuck to a first face of the magnetic layer by adhesive. The lower surface layer is a thin layer made of flexible material. The lower surface layer is stuck to a second face of the magnetic layer by adhesive.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a magnetic tool rack in accordance with the preferred embodiment of the present invention.

FIG. 2 is an exploded perspective view of the magnetic tool rack in accordance with the preferred embodiment of the present invention.

FIG. 3 is a schematic perspective operational view of the magnetic tool rack that is used for a car.

FIG. 4 is a partial cross-sectional view of the magnetic tool rack and the car as shown in FIG. 3.

FIG. 5 is a locally enlarged view of the magnetic tool rack and the car as shown in FIG. 3, wherein hand tools are attached to the magnetic tool rack.

FIG. 6 is a schematic perspective operational view of the magnetic tool rack that is used for a car.

FIG. 7 is a locally enlarged view of the magnetic tool rack and the car as shown in FIG. 6.

FIG. 8 is a schematic perspective operational view of the magnetic tool rack that is used for a machine.

### DETAILED DESCRIPTION OF THE INVENTION

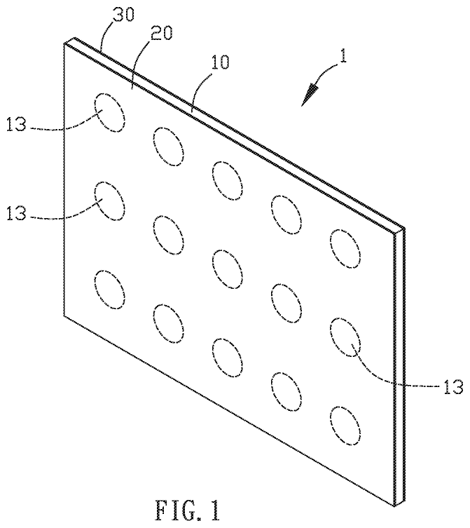

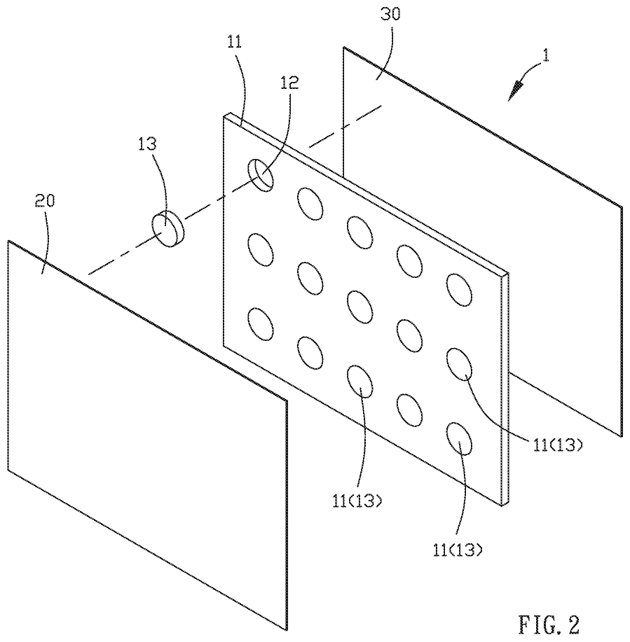

Referring to the drawings and initially to FIGS. 1 and 2, a magnetic tool rack 1 (or board or holder) in accordance with the preferred embodiment of the present invention comprises a magnetic layer 10, an upper surface layer 20 mounted on the magnetic layer 10, and a lower surface layer 30 mounted on the magnetic layer 10.

The magnetic layer 10 includes a plank 11 provided with a plurality of mounting grooves 12, and a plurality of magnetic members 13 mounted in the mounting grooves 12 of the plank 11. The plank 11 of the magnetic layer 10 is made of flexible material. The magnetic members 13 have magnetic poles that are directed at the same direction in the mounting grooves 12.

The upper surface layer 20 is a thin layer made of flexible material, such as a plastic epidermis (or coating or scarfskin). The upper surface layer 20 is stuck to a first face of the magnetic layer 10 by adhesive.

The lower surface layer 30 is a thin layer made of flexible material, such as a plastic epidermis (or coating or scarfskin). The lower surface layer 30 is stuck to a second face of the magnetic layer 10 by adhesive.

In the preferred embodiment of the present invention, the magnetic layer 10 is located between the upper surface layer 20 and the lower surface layer 30, and the magnetic members 13 are located between the upper surface layer 20 and the lower surface layer 30.

In the preferred embodiment of the present invention, the plank 11 of the magnetic layer 10 is made of a sponge, rubber or silicone (silica gel). Alternatively, the plank 11 of the magnetic layer 10 is made of plastic material that is bendable.

In the preferred embodiment of the present invention, the plank 11 of the magnetic layer 10 has a geometric shape, such as rectangular, square, circular or polygonal shape, and each of the upper surface layer 20 and the lower surface layer 30 has a shape the same as that of the plank 11 of the magnetic layer 10.

In the preferred embodiment of the present invention, the magnetic members 13 have north (N) poles that are directed downward in the mounting grooves 12 simultaneously. Alternatively, the magnetic members 13 have south (S) poles that are directed downward in the mounting grooves 12 simultaneously.

In the preferred embodiment of the present invention, each of the upper surface layer 20 and the lower surface layer 30 is made of plastic material, such as a plastic epidermis.

In assembly, the magnetic members 13 are inserted into the mounting grooves 12 of the plank 11 to construct the magnetic layer 10. Then, the upper surface layer 20 is stuck to the first face of the magnetic layer 10, and the lower surface layer 30 is stuck to the second face of the magnetic layer 10, such that the magnetic members 13 are limited in the mounting grooves 12 of the plank 11 and located between the upper surface layer 20 and the lower surface layer 30. At this time, each of the upper surface layer 20 and the lower surface layer 30 is a thin layer and will not affect the magnetically attracting force of the magnetic members 13.

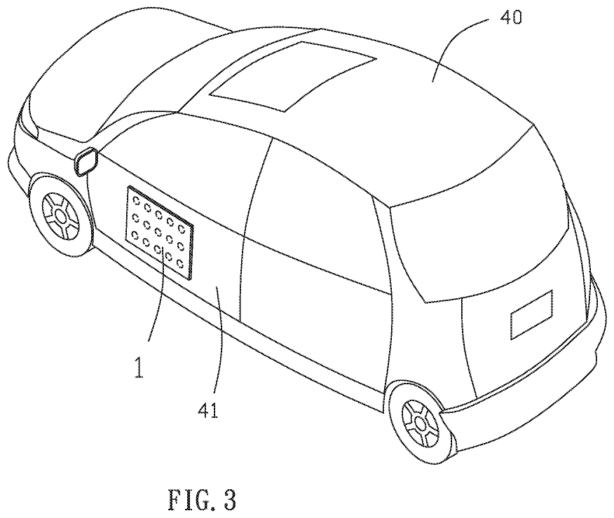

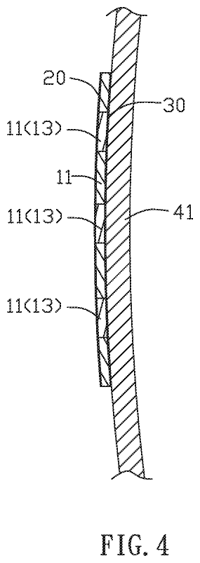

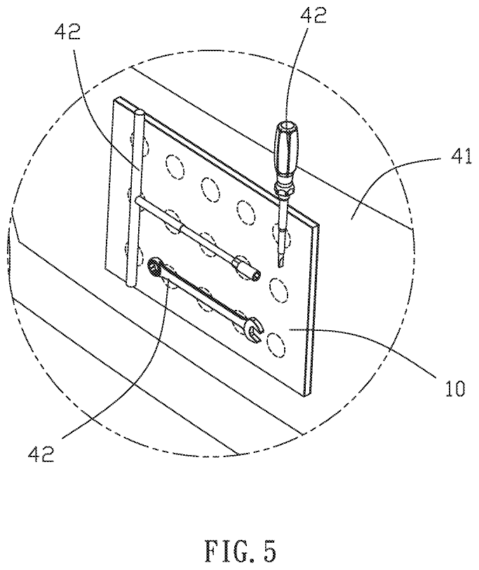

In operation, referring to FIGS. 3-5 with reference to FIGS. 1 and 2, the magnetic tool rack 1 is placed on a door 41 of a car 40 for magnetically attracting hand tools 42, such as wrenches, screwdrivers, sockets or the like. At this time, the lower surface layer 30 of the magnetic tool rack 1 is attached to the door 41 of the car 40, and the hand tools 42 are attached to the upper surface layer 20 of the magnetic tool rack 1. In such a manner, the magnetic members 13 are arranged and distributed on the plank 11 completely, such that the magnetic layer 10 is attached to the door 41 of the car 40 exactly and steadily by the point-to-point (or multi-point) magnetic attraction of the magnetic members 13, and the hand tools 42 are attached to the magnetic layer 10 exactly and steadily by the point-to-point (or multi-point) magnetic attraction of the magnetic members 13, thereby facilitating the user operating the hand tools 42. In addition, each of the plank 11 of the magnetic layer 10, the upper surface layer 20, and the lower surface layer 30 is made of flexible material, such that the magnetic tool rack 1 is bent and flexed corresponding to the profile of the door 41. Thus, the magnetic tool rack 1 is attached to the door 41 of the car 40 tightly and closely. Further, the magnetic members 13 have magnetic poles that are directed at the same direction, such that the user attaches the magnetic tool rack 1 to the door 41 of the car 40 easily, without having to distinguish the magnetic attraction direction of the magnetic tool rack 1. Further, the magnetic tool rack 1 is flexed to fit an arcuate surface.

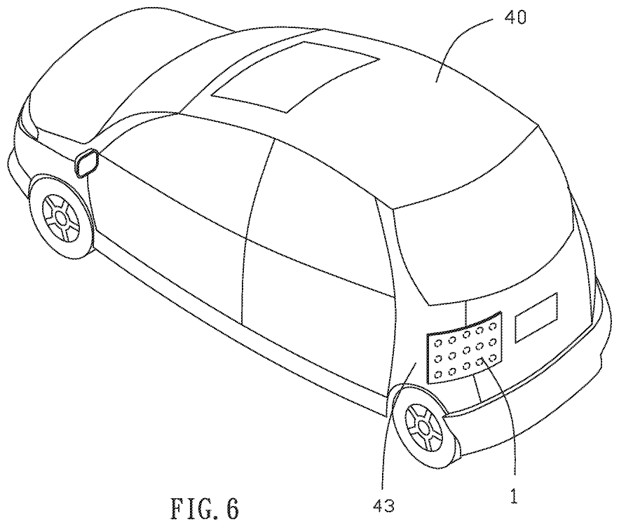

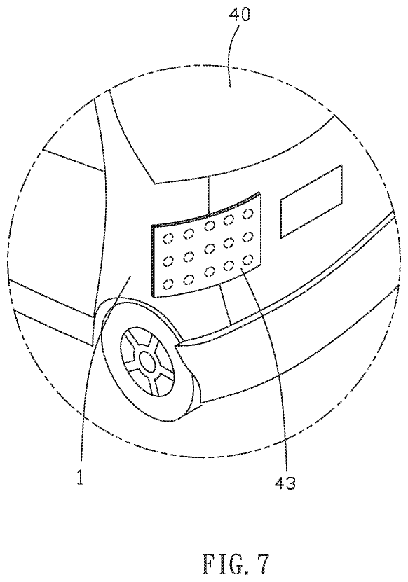

Referring to FIGS. 6 and 7 with reference to FIGS. 1 and 2, the magnetic tool rack 1 is directly attached to a car body 43 of the car 40 by magnetic attraction. At this time, the magnetic tool rack 1 is bent and flexed corresponding to the profile of the car body 43.

Alternatively, the magnetic tool rack 1 is magnetically attached to any metal part of the car 40, such as the chassis, the engine room, the car top or the like. In addition, the magnetic tool rack 1 is flexed to fit a flat surface or an arcuate surface.

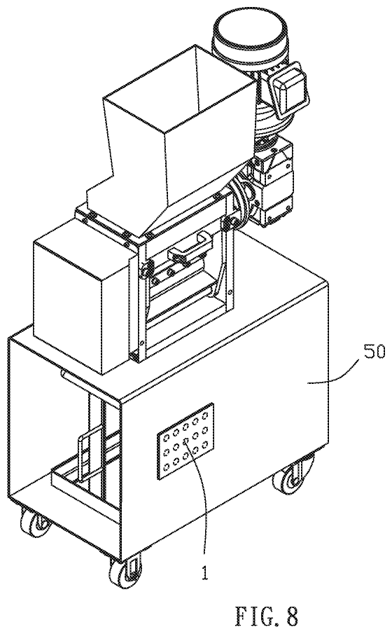

Referring to FIG. 8 with reference to FIGS. 1 and 2, the magnetic tool rack 1 is attached to any metal part of a machine 50 magnetically.

Alternatively, the magnetic tool rack 1 is magnetically attached to the steel skeleton of a construction place, to store or hold a ruler, a metal part or the like.

Alternatively, the magnetic tool rack 1 is magnetically attached to the metal cabinet of an office, to store or hold a metal stationery utensil.

Accordingly, the magnetic members 13 are arranged and distributed on the plank 11 completely, such that the magnetic layer 10 is attached to a metal surface exactly and steadily, and a metal hand tool is attached to the magnetic layer 10 closely and tightly. In addition, the magnetic layer 10 is flexed to fit a plane surface or a non-plane (or arcuate) surface.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A magnetic tool rack comprising:
a magnetic layer attracted to a metal surface magnetically;
an upper surface layer mounted on the magnetic layer; and
a lower surface layer mounted on the magnetic layer;
wherein:
the magnetic tool rack is magnetically attached to the metal surface by a magnetic action of the magnetic layer;
the magnetic layer includes a plank provided with a plurality of mounting grooves, and a plurality of magnetic members mounted in the mounting grooves of the plank, wherein each of the plurality of magnetic members is fully received in one of the plurality of mounting grooves of the plank;
the plank of the magnetic layer is made of flexible material;
the magnetic members have magnetic poles that are directed at the same direction in the mounting grooves;
the upper surface layer is a thin layer made of flexible material;
the upper surface layer is stuck to a first face of the magnetic layer by adhesive;
the lower surface layer is a thin layer made of flexible material; and
the lower surface layer is stuck to a second face of the magnetic layer by adhesive.

2. The magnetic tool rack of claim 1, wherein the plank of the magnetic layer is made of a sponge.

3. The magnetic tool rack of claim 1, wherein the plank of the magnetic layer is made of rubber.

4. The magnetic tool rack of claim 1, wherein the plank of the magnetic layer is made of silicone.

5. The magnetic tool rack of claim 1, wherein the plank of the magnetic layer 10 is made of plastic material that is bendable.

6. The magnetic tool rack of claim 1, wherein the plank of the magnetic layer has a geometric shape, including rectangular, square, circular or polygonal shape, and each of the upper surface layer and the lower surface layer has a shape the same as that of the plank of the magnetic layer.

7. The magnetic tool rack of claim 1, wherein the magnetic members have north poles that are directed downward in the mounting grooves simultaneously.

8. The magnetic tool rack of claim 1, wherein the magnetic members have south poles that are directed downward in the mounting grooves simultaneously.

9. The magnetic tool rack of claim 1, wherein each of the upper surface layer and the lower surface layer is made of plastic epidermis.

10. The magnetic tool rack of claim 1, wherein each of the magnetic members has a thickness equal to that of each of the mounting grooves of the plank.

11. The magnetic tool rack of claim 1, wherein each of the magnetic members has a thickness equal to that of the plank.

12. The magnetic tool rack of claim 1, wherein the magnetic members are magnetically attracted to the metal surface.

13. The magnetic tool rack of claim 1, wherein the magnetic members attach one of the upper surface layer and the lower surface layer to the metal surface.

14. The magnetic tool rack of claim 1, wherein each of the upper surface layer and the lower surface layer is attachable to the metal surface by a magnetic interaction of the magnetic members.

15. The magnetic tool rack of claim 1, wherein a metal object is attached to the metal surface by a magnetic interaction of the magnetic members.

16. The magnetic tool rack of claim 1, wherein the upper surface layer is a single layer.
